(19) United States
(12) Patent Application Publication
(10) Pub. No.: US 2025/0243847 A1
(43) Pub. Date: Jul. 31, 2025

(54) WIND TURBINE TOWER DETACHABLE SELF ERECTING SYSTEM FOR ALL WIND TURBINE COMPONENTS

(71) Applicant: CLS Wind LLC, Houston, TX (US)

(72) Inventors: Andres C. Garcia, Missouri City, TX (US); Kent A. Johnson, Houston, TX (US)

(21) Appl. No.: 18/854,538

(22) PCT Filed: Mar. 29, 2023
(86) PCT No.: PCT/US2023/016660

§ 371 Date: Oct. 11, 2024

Related U.S. Application Data
(60) Provisional application No. 63/329,537, filed on Apr. 11, 2022.

(51) Int. Cl. F03D 13/10; B66B 9/00; B66B 9/02; E04H 12/34

(52) U.S. Cl. CPC F03D 13/112; B66B 9/00; B66B 9/022; E04H 12/342; F05B 2230/61

(57) ABSTRACT

A tower assembly system can include a self-climbing platform that can carry a load to a determined height, which once attained, can place the load into position. A method for assembling a wind turbine can involve placing a first tower section in an upright position on a tower base and using an elevator assembly platform attached to the first tower section to elevate, position and connect subsequent tower sections until the subsequent tower sections are located directly above the first tower section in a vertical tower assembly. The elevator assembly platform can perform vertical displacement operations and lateral displacement operations with respect to one or more components of the wind turbine, such as, for example, the first and subsequent tower sections, nacelle, blades, etc.

### CROSS REFERENCE TO PATENT APPLICATION

This patent application is a 35 U.S.C. § 371 United States national stage application filing of International Application No. PCT/US2023/016660 filed Mar. 29, 2023, entitled “Wind Turbine Tower Detachable Self Erecting System for All Wind Turbine Components,” which designates the United States, and which in turn claims priority under the Patent Cooperation Treaty to U.S. Provisional Patent Application Ser. No. 63/329,537 filed on Apr. 11, 2022. International Application No. PCT/US2023/016660 and U.S. Provisional Patent Application Ser. No. 63/329,537 are incorporated herein by reference in their entirety.

### TECHNICAL FIELD

Embodiments are related to devices, methods, and systems for assembling towers including, but not limited to wind turbine towers. Embodiments further relate to a removable/detachable turbine tower rack/rail system, and elevator assembly devices and platforms used for the assembly of wind turbine towers and other types of towers.

### BACKGROUND

Wind power is considered one of the cleanest, most environmentally friendly energy sources presently available, and wind turbines have gained increased attention in this regard. Wind turbines are used to convert kinetic energy of wind into electrical power. A modern wind turbine typically includes a tower, a generator, a gearbox, a nacelle, and one or more rotor blades. The rotor blades capture kinetic energy from wind using known airfoil principles and transmit the kinetic energy through rotational energy to turn a main shaft coupling the rotor blades to a gearbox, or if a gearbox is not used, directly to the generator. The generator can then convert the mechanical energy to electrical energy, which may be deployed to a utility grid, and stored or used for other local means. A wind turbine may include a substantially large-sized rotor (e.g., wheel) coupled to the nacelle disposed at the top end of a tower. The nacelle can include a generator for producing electrical power from rotary motion energy produced by the rotor.

Conventionally, installation, repair, repowering and decommissioning of such wind turbines requires at least one large sized crane system, which may need to be robust enough for reaching and lifting heavy loads to considerable heights while installing, repairing, repowering or decommissioning the wind turbine. The wind turbine may generally extend several tens of meters above ground level or sea level. Typically, such large sized crane systems are scarce and expensive to mobilize, setup and install at a wind turbine site.

Wind turbine installation for such large sized power capacity systems may involve traditional crane installation techniques or so-called ‘craneless’ approaches. FIG. 1A, for example, depicts an image of a traditional crane installation approach. FIG. 1B, on the other hand, shows a craneless approach involving a tower grab system. An example of such a tower grab system is disclosed in U.S. Pat. No. 10,494,235, which is incorporated herein by reference in its entirety.

Another example of a craneless approach is shown in FIG. 1C, which illustrates a tower crane type application used for wind turbine installations, next to a wind turbine tower. Another example of a craneless installation technique can involve the use of a tower crane that runs a climbing tower with modified wind turbine power. A further example of a craneless system involves the use of a rail on a tower with either a conveyor or a crane on a carriage. An example of this approach is disclosed in U.S. Pat. No. 9,261,072, which is incorporated herein by reference in its entirety.

Currently used, conventional technologies thus use some variation of a method of assembly of wind turbine towers by lifting the components into position with a crane or cranes, or may involve some form of craneless installation system, such as discussed above.

With the increase in height and weight of wind turbines and related components, the need for large size, heavy lift cranes (onshore) and (offshore) heavy-lift or wind turbine installation vessels (WTIV) are ever more present. There is not enough of this large size equipment to supply the world with installation or repair capacity, and this will cause bottlenecks and delays in many wind farm projects.

In addition, both the costs and time that takes to install this equipment is very high and extensive. There are better installation methods that would allow for parallel installations, saving time and cost to the end user/owner.

Environmental damage and carbon emission reductions are also issues of great public interest. Our system also aims to reduce the environmental footprint by minimizing the area utilized and civil work required at the wind turbine site, as well as the access roads, by using the smallest possible cranes and as few transport loads as possible.

Operational weather windows are also short, especially in northern locations with colder weather, and having the ability to extend the operational window will allow for more efficient operations and time savings.

In addition, there are many areas of the world that do not have either the resources or the capacity to obtain this large, heavy equipment, but where it is desired to install large capacity wind turbines. This goal may be unable to be achieved, however, due to the scarcity of installation resources. The present inventors thus propose a solution to the above problems that aims to allow any country, company, or person, to install any wind turbine capacity and size that is desired, utilizing existing, small or medium capacity cranes and fewer resources.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, an aspect of the embodiments to provide for an improved wind turbine installation method and system.

It is another aspect of the embodiments to provide for a method and system for assembling a wind turbine tower.

It is further aspect of the embodiments to provide for a removable/detachable wind turbine tower rack/rail method and system.

The aforementioned aspects and other objectives and advantages can now be achieved as described herein.

In an embodiment, a tower assembly system, can comprise a self-climbing platform that can carry a load to a determined height, which once attained, can place the load into position.

In an embodiment, a method for assembling a wind turbine, can involve placing a first tower section in an upright position on a tower base; and using an elevator assembly platform attached to the first tower section to elevate, position and connect subsequent tower sections until the subsequent tower sections are located directly above the first tower section in a vertical tower assembly. The elevator assembly platform is operable to perform vertical displacement operations and lateral displacement operations with respect to at least one component of the wind turbine including the first and subsequent tower sections.

In an embodiment, the elevator assembly platform can include an elevator, a lateral displacement carrier, and at least one counterweight.

An embodiment can further involve transferring the at least one component of the wind turbine to a final location with the lateral displacement carrier.

An embodiment can further involve transferring the at least one component of the wind turbine to a height, wherein the at least one counterweight can be placed on an opposite side of the lateral displacement carrier to compensate for a moment generated by a weight of the at least one component, wherein once at a corresponding height, the lateral displacement carrier can move the at least one component for placement above a previously installed component and the at least one counterweight can move in an opposite direction for balancing.

An embodiment can further involve facilitating the vertical displacement operations with a rack and pinion system comprising a rack and at least one pinion, wherein the rack is arranged in a vertical position connected to at least one tower among the subsequent tower sections, and the at least one pinion is located in the elevator as a part of a drive system.

An embodiment can further involve facilitating the vertical displacement operations with a winch hoist system comprising a rail and at least one winch, wherein the rail is arranged in a vertical position connected to at least one tower among the subsequent tower sections, and the at least one winch is located in the elevator or ground as a part of a lifting system.

An embodiment can further involve facilitating the vertical displacement operations with a chain hoist system comprising a rail and at least one winch, wherein the rail is arranged in a vertical position connected to at least one tower among the subsequent tower sections, and the at least one chain hoist is located in the elevator as a part of a lifting system.

An embodiment can further involve facilitating the vertical displacement operations with a rack and pinion system comprising a rack and at least one pinion, wherein the rack is arranged in a vertical position connected to at least one tower among the subsequent tower sections, and the at least one pinion is located in the elevator as a part of a drive system; facilitating the vertical displacement operations with a winch hoist system comprising a rail and at least one winch, wherein the rail is arranged in a vertical position connected to at least one tower among the subsequent tower sections, and the winch(s) is located in the elevator or ground as a part of a lifting system; and/or facilitating the vertical displacement operations with a chain hoist system comprising of a rail and at least one winch, wherein the rail is arranged in a vertical position connected to at least one tower among the subsequent tower sections, and the chain hoist(s) is located in the elevator as a part of a lifting system.

An embodiment can further involve adding at least one intermediate flange to the first tower section and the subsequent tower sections without modifying existing components associated with the first and subsequent tower sections or without using existing connection points associated with first and subsequent tower sections.

In embodiment, the components of the wind turbine can include, for example, one more components such as a tower section, a nacelle, a hub, a drive train, and wind turbine blades (also referred to simply as ‘blades’).

In an embodiment, the elevator assembly platform 150 can perform two main operations: a vertical displacement and a lateral displacement operation. The vertical displacement can be achieved by one or more of: a) a rack and pinion system where the rack is in a vertical position connected to the tower and the pinion(s) are in the elevator itself (as part of a drive system); b) a winch hoist system where the guide rail is in a vertical position connected to the tower; and c) a chain hoist where the guide rail is in vertical position connected to the tower.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1A illustrates a diagram of a prior art crane installation system;

FIG. 1B illustrates an image of a craneless prior art grab system;

FIG. 1C illustrates an image of a craneless prior art system having a tower crane that is run next to a wind turbine;

FIG. 2A illustrates a schematic diagram of tower sections that can be implemented in accordance with an embodiment;

FIG. 2B illustrates a schematic diagram of a tower base in accordance with an embodiment;

FIG. 2C illustrates an image of a tower base, which can be implemented in accordance with an embodiment;

FIG. 2D illustrates a side view of a tower base, in accordance with an embodiment;

FIG. 3A illustrates a schematic diagram of a tower bottom section with an elevator platform installed, in accordance with an embodiment;

FIG. 3B illustrates a schematic diagram of a tower bottom section with an elevator platform installed, in accordance with an embodiment;

FIG. 3C illustrates a schematic diagram of an elevator platform with a next tower section, in accordance with an embodiment; and

FIG. 3D illustrates a side view schematic diagram of a complete tower, in accordance with an embodiment.

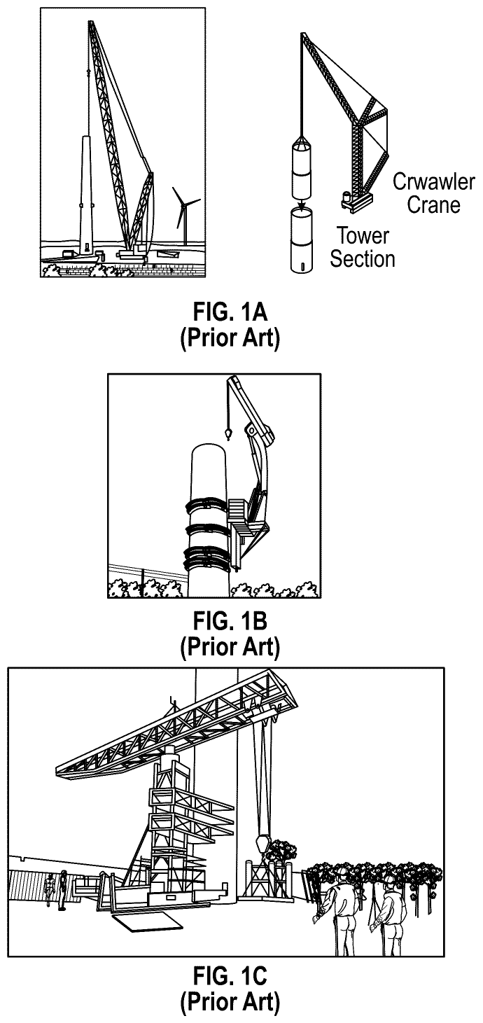

Like reference numerals utilized herein can refer to identical or similar parts or elements.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context.

In addition, the term “based on” may be understood as not necessarily intended to convey an exclusive set of factors and may, instead, allow for existence of additional factors not necessarily expressly described, again, depending at least in part on context. Furthermore, the phrase “at least one” may be understood to convey the meaning “one or more”. For example, “at least one widget” may convey the concept of “one or more widgets”.

As noted previously, currently used, conventional tower assembly technologies can use wind turbine tower assembly methods that involve lifting the wind turbine components into position with a crane. New approaches are being developed, which attempt to adapt conventional crane technologies for the erection of wind turbine components. These new approaches, such as climbing cranes, tower cranes and others, either utilize the wind turbine tower as its support foundation or member, or erect a box, lattice, or similar structure to install a jib or crane system.

As will become apparent as discussed in greater detail below, the disclosed embodiments do not use such previously discussed assembly techniques in either conventional or adaptations but includes its own unique track system to elevate a self-climbing platform to carry the loads up to a determine height, which once reached, can function with a lateral translated motion to place the load into position. Key novel features of the embodiments include continuous vertical and lateral motion/displacement; no limits on load and height capacity; load always secured into position (no swinging or pendulum issues) with controlled movements; and the ability to be used both onshore and offshore.

The embodiments allow a user to lift any weight to any height, whether onshore or offshore, without the need for large, high reaching, high-capacity cranes, for the installation of a complete wind turbine and/or its components. The embodiments also allows for smaller loads to be transported to the installation or repair site, minimizing both the environmental impact and reducing carbon emissions, versus conventional systems who have large mobilizations, great numbers of loads and heavy environmental impacts and carbon emissions.

The embodiments involve the assembly of a wind turbine tower with a removable/detachable wind turbine tower rack/rail system.

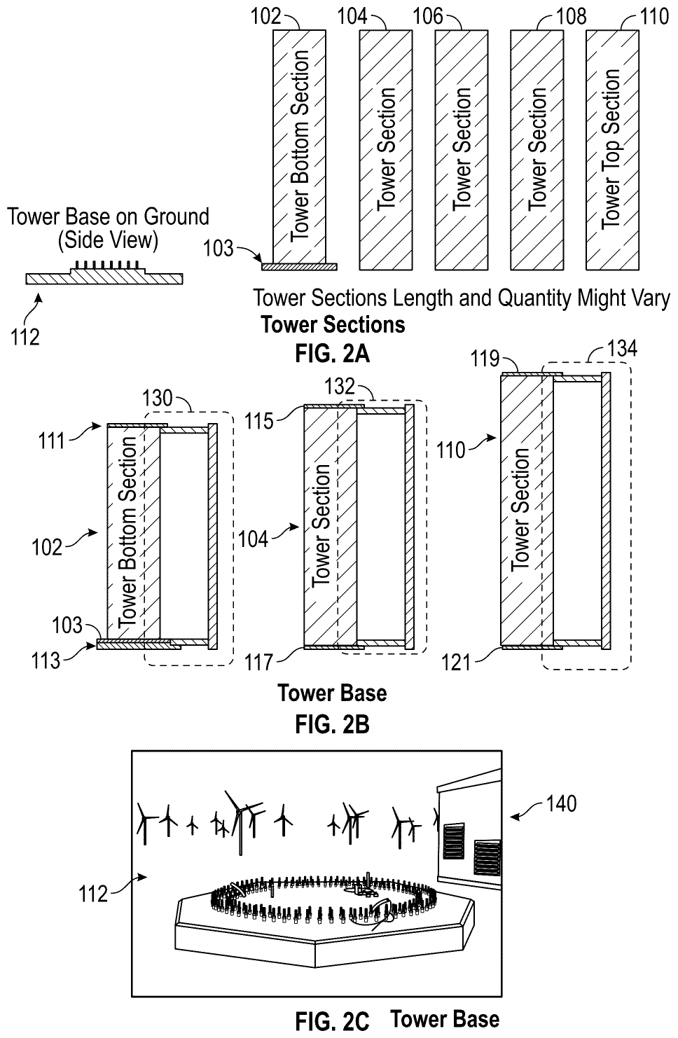

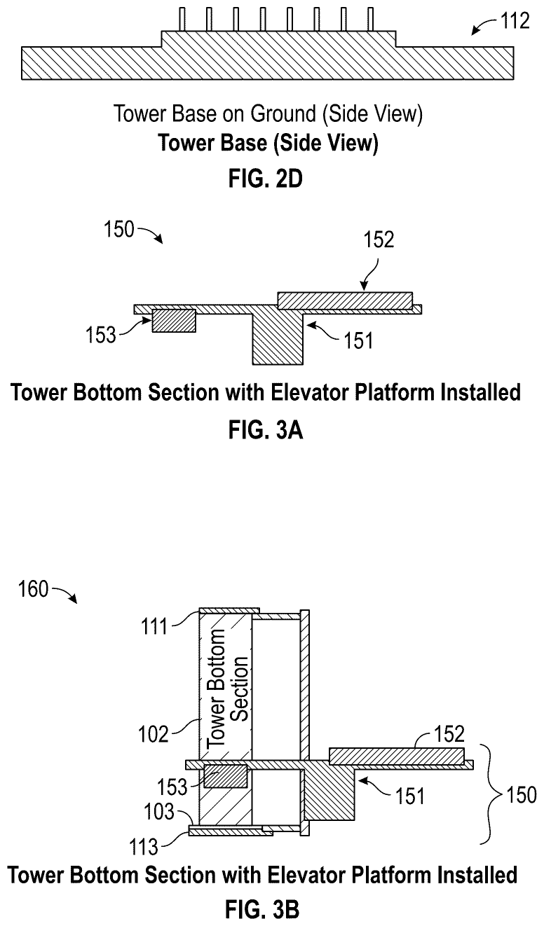

FIG. 2A illustrates a schematic diagram of varying tower sections, one or more of which may be used for the assembly of a wind turbine tower, in accordance with an embodiment. A tower therefore may include one or more original equipment manager (OEM) tower sections including, but not limited to a tower bottom section 102, a tower top section 110 and one or more tower sections 104, 106, 108. The tower bottom section may include a base portion 103 that can be connected to a tower base 112.

The tower bottom section 102, the tower top section 110 and the tower sections 104, 106, 108 may have varying lengths and the quantity may vary. That is, it can be appreciated that in some embodiments additional or fewer tower sections may be needed. The tower bottom section 102 may be installed upon a tower base 112. In the example shown in FIG. 2A, the tower base 112 is depicted in a side view as a tower base located on the ground.

FIG. 2B illustrates varying tower sections, which can be configured for assembly for a wind turbine tower using intermediate flanges on the top and bottom of each tower section in accordance with an embodiment. An intermediate flange 111 can be added to the top of the tower bottom section 102, while an intermediate flange 113 can be added to the bottom of the tower bottom section 102. Similarly, an intermediate flange 115 may be added to the top of the tower section 104, and an intermediate flange 117 added to the bottom of the tower section 104. Likewise, an intermediate flange 119 can be added to the top of the tower top section 110, and an intermediate flange 121 added to the bottom of the tower top section 110.

FIG. 2C illustrates an image 140 of the tower base 112, which can be implemented in accordance with an embodiment. FIG. 2D illustrates a side view schematic diagram of the tower base 112, in accordance with an embodiment.

The embodiments can use OEM provided tower sections (e.g., such as shown in FIG. 2A), with the addition of an intermediate flange on the top and bottom of each tower section without permanently modifying existing components or using an OEM existing connection point. Then, a detachable rail/rack system 130 along each tower section can be implemented with a corresponding tie-in prior to the assembly process (FIG. 2B), followed by placing the first tower section (FIG. 2C) in an upright position on the tower base (FIG. 2D).

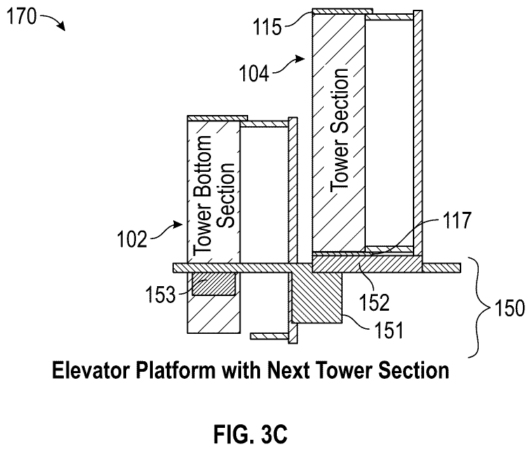

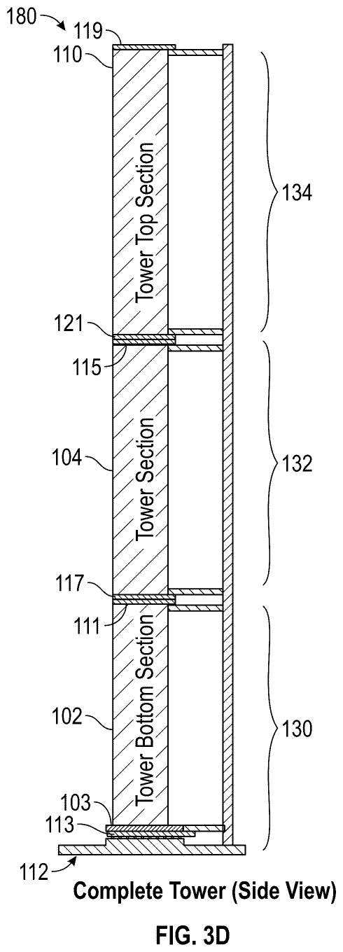

FIG. 3A illustrates a side view of an elevator assembly platform 150, in accordance with an embodiment. FIG. 3B illustrates a side view of a system 160 including the elevator assembly platform 150 shown in FIG. 3A installed on the tower bottom section 102, in accordance with an embodiment. The elevator assembly platform 150 includes an elevator 151, a lateral displacement carrier 152, and a counterweight 153. The elevator assembly platform 150 can be installed on or with the tower bottom section 102 discussed above in FIG. 2A to FIG. 2D. The installation of the elevator assembly platform 150 with respect to the tower bottom section 102 is shown in FIG. 3B.

FIG. 3C illustrates a side view of a system 170 that includes the elevator assembly platform 150 in an assembly in which the elevator assembly platform 150 is collocated with the next tower section. This next tower section includes the tower section 104, which his generally shown as located on and above the lateral displacement carrier 152. FIG. 3D illustrates a side view of the complete tower 180 including the various tower sections and components.

FIG. 3A to FIG. 3D thus illustrate a wind turbine tower rack/rail assembly system that includes systems and components such as the elevator assembly platform 150 and systems 160, 170, and 180.

The elevator assembly platform 150 includes the elevator 151 itself, the lateral displacement carrier 152, and counterweight(s) 153. The tower base 112 can be used with a tower base guide rail and the elevator assembly platform 150. The elevator 151 is movable along the tower base guide rack/rail and can includes a two operation mechanism for the assembly of the rest of the tower sections components.

The elevator assembly platform 150 can perform two important operations: a vertical displacement and a lateral displacement operation. The vertical displacement can be achieved by one or more of: a) a rack and pinion system where the rack is in a vertical position connected to the tower and the pinion(s) are in the elevator 151 itself (as part of a drive system); b) a winch hoist system where the guide rail is in a vertical position connected to the tower; and c) a chain hoist where the guide rail is in vertical position connected to the tower.

The displacement provided by the lateral displacement carrier 152 can be used to position the components (e.g., tower sections, nacelle, hub, drive train, blades, etc.) in location once the corresponding height is reached. Then, the components can be securely transferred to their final location via the lateral displacement carrier 152.

In the process of elevating the component to the height, the counterweight 153 can be placed in the opposite side of the lateral displacement carrier 152 to compensate for the moment generated by the weight of the component. Once at the corresponding height, the lateral displacement carrier 152 can move the component to place it above the previously installed piece, and the counterweight 153 can move in the opposite direction to keep all forces balanced.

Additional operational steps implementing for assembling all wind turbine components, can involve elevating, positioning and connecting all tower sections after the tower bottom section is placed in position; elevating, positioning and connecting a nacelle and/or other related components; and elevating, positioning and connecting blades to the hub.

Key novel features of the embodiments thus can include continuous vertical and lateral motion/displacement; no limits on load and height capacity; the load always secured into position (e.g., no swinging or pendulum issues) with controlled movements; and the ability to be used both onshore and offshore.

The present inventors believe that the disclosed embodiments are an improvement over conventional approaches because these embodiments allow a user to lift any weight to any height, whether onshore or offshore, without the need for large, high reaching, high-capacity cranes, to install, repair, replace, repower or decommission a complete wind turbine and/or its components. The embodiments also allow for smaller loads to be transported to the installation or repair site, minimizing both the environmental impact and reducing carbon emissions, versus conventional systems who have large mobilizations, great numbers of loads and heavy environmental impacts and carbon emissions.

With the increase in height and weight of wind turbines and related components, the need for large size, heavy lift cranes (onshore) and (offshore) heavy-lift or wind turbine installation vessels (WTIV) is ever more present. There is not enough of this large size equipment to supply the world with installation or repair capacity, and this will cause bottlenecks and delays in many wind farm projects.

In addition, both the cost and time that it takes to install this equipment can are significant. There are better installation methods that can allow for parallel installations, saving time and cost to the end user/owner.

Environmental damage and carbon emission reductions are also issues of great public interest. Our system also aims to reduce the environmental footprint by minimizing the area utilized at the wind turbine site, as well as the access roads, by using the smallest possible cranes and as few transport loads as possible.

Operational weather windows are also short, especially in norther locations with colder weather, and having the ability to extend the operational window will allow for more efficient operations and time savings.

In addition, there are many areas of the world that do not have either the resources or the capacity to obtain this large, heavy equipment, but they want to install large capacity wind turbines and will be unable to do it due to the scarcity of installation resources. With our invention, we aim to allow any country, company, or person, to install any wind turbine capacity and size that is desired, utilizing existing, small capacity cranes and fewer resources, including the utilization of local personnel. The embodiments aims to solve all of the above issues, and more.

Potential applications and areas of use for the disclosed embodiments can include, for example, wind turbine towers for onshore and offshore use, telecommunication towers, tower cranes, transmission lines or towers, dam and similar infrastructure construction projects, space or aerospace related industries, any industry or activity that needs to lift heavy weight to large heights, offshore construction and/or repair companies that use lifting and handling systems in their operations, and EPIC/EPCI (Engineering, procurement, installation, and commissioning).

Note that in some embodiments, a connection point may be added to the towers for easy connect and disconnect operations, which might be part of the OEM tower if approved or the use of at least one intermediate flange or similar to the first tower section and the subsequent tower sections without modifying existing components associated with the first and subsequent tower sections or without using existing connection points associated with the first and subsequent tower sections.

A tower assembly system can thus include a self-climbing platform that can carry a load to a determined height, which once attained, can translate motion to place the load into a position. A method for assembling a wind turbine can involve placing a first tower section in an upright position on a tower base and using an elevator assembly platform attached to the first tower section to elevate, position, and connect subsequent tower sections until the subsequent tower sections are located directly above the first tower section in a vertical tower assembly. The elevator assembly platform is operable to perform vertical displacement operations and lateral displacement operations with respect to one or more components of the wind turbine, such as, for example, the first and subsequent tower section, nacelle, blades, and so on.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A tower assembly system, comprising:
a self-climbing platform that carries a load to a determined height, which once attained, places the load into a position.

2. The tower assembly system of claim 1 wherein the load comprises a first tower section and subsequent tower sections.

3. The tower assembly of claim 2 wherein the self-climbing platform places the first tower section in an upright position on a tower base.

4. The tower assembly of claim 2 wherein the self-climbing platform further includes an elevator assembly platform attached to a first tower section rail/rack to elevate, position and connect the subsequent tower sections until the subsequent tower sections are located directly above the first tower section in a vertical tower assembly, wherein the elevator assembly platform performs vertical displacement operations and lateral displacement operations with respect to at least one component of a wind turbine including the first and subsequent tower sections.

5. A method for assembling a wind turbine, comprising:
placing a first tower section in an upright position on a tower base; and
using an elevator assembly platform attached to a first tower section rail/rack to elevate, position and connect subsequent tower sections until the subsequent tower sections are located directly above the first tower section in a vertical tower assembly, wherein the elevator assembly platform performs vertical displacement operations and lateral displacement operations with respect to at least one component of the wind turbine including the first and subsequent tower sections.

6. The method of claim 5 wherein the elevator assembly platform comprises:
an elevator;
a lateral displacement carrier; and
at least one counterweight.

7. The method of claim 6 further comprising:
transferring the at least one component of the wind turbine to a final location with the lateral displacement carrier.

8. The method of claim 6 further comprising:
transferring the at least one component of the wind turbine to a height, wherein the at least one counterweight is placed on an opposite side of the lateral displacement carrier to compensate for a moment generated by a weight of the at least one component;
wherein once at a corresponding height, the lateral displacement carrier moves the at least one component for placement above a previously installed component and the at least one counterweight moves in an opposite direction for balancing.

9. The method of claim 6 further comprising:
facilitating the vertical displacement operations with a rack and pinion system comprising a rack and at least one pinion, wherein the rack is arranged in a vertical position connected to at least one tower among the subsequent tower sections, and the at least one pinion is located in the elevator as a part of a drive system.

10. The method of claim 6 further comprising:
facilitating the vertical displacement operations with a winch hoist system comprising a rail and at least one winch, wherein the rail is arranged in a vertical position connected to at least one tower among the subsequent tower sections, and the at least one winch is located in the elevator or ground as a part of a lifting system.

11. The method of claim 6 further comprising:
facilitating the vertical displacement operations with a chain hoist system comprising a rail and at least one winch, wherein the rail is arranged in a vertical position connected to at least one tower among the subsequent tower sections, and the at least one chain hoist is located in the elevator as a part of a lifting system.

12. The method of claim 6 further comprising:
facilitating the vertical displacement operations with a rack and pinion system comprising a rack and at least one pinion, wherein the rack is arranged in a vertical position connected to at least one tower among the subsequent tower sections, and the at least one pinion is located in the elevator as a part of a drive system;
facilitating the vertical displacement operations with a winch hoist system comprising a rail and at least one winch, wherein the rail is arranged in a vertical position connected to at least one tower among the subsequent tower sections, and the at least one winch is located in the elevator or ground as a part of a lifting system; and/or
facilitating the vertical displacement operations with a chain hoist system comprising a rail and at least one winch, wherein the rail is arranged in a vertical position connected to at least one tower among the subsequent tower sections, and the at least one chain hoist is located in the elevator as a part of a lifting system.

13. The method of claim 5 wherein the components of the wind turbine further comprise at least one of: a nacelle, a hub, a drive train, and blades.

14. The method of claim 6 wherein the components of the wind turbine are receivable from at least one of: a trailer, a truck or a supply ramp, into an adjustable incline loading ramp for easy loading into the lateral displacement carrier of the elevator assembly platform.

15. A system for assembling a wind turbine, comprising:
an elevator assembly platform attachable to a first tower section rail-rack to elevate, position and connect subsequent tower sections until subsequent tower sections are located directly above a first tower section in a vertical tower assembly, wherein the elevator assembly platform performs vertical displacement operations and lateral displacement operations with respect to at least one component of the wind turbine including the first and subsequent tower sections.

16. The system of claim 15 wherein the elevator assembly platform comprises:
an elevator;
a lateral displacement carrier; and
at least one counterweight.

17. The system of claim 16 wherein the at least one component of the wind turbine is transferrable to a final location with the lateral displacement carrier.

18. The system of claim 16 wherein:
the at least one component of the wind turbine is transferrable to a height, wherein the at least one counterweight is placed on an opposite side of the lateral displacement carrier to compensate for a moment generated by a weight of the at least one component;
wherein once at a corresponding height, the lateral displacement carrier moves the at least one component for placement above a previously installed component and the at least one counterweight moves in an opposite direction for balancing.

19. The system of claim 16 wherein:
the vertical displacement operations are facilitated with a rack and pinion system comprising a rack and at least one pinion, wherein the rack is arranged in a vertical position connected to at least one tower among the subsequent tower sections, and the at least one pinion is located in the elevator as a part of a drive system.

20. The system of claim 16 further comprising:
wherein the vertical displacement operations are facilitated with a winch hoist system comprising a rail and at least one winch, wherein the rail is arranged in a vertical position connected to at least one tower among the subsequent tower sections, and the at least one winch is located in the elevator or ground as a part of a lifting system.

21. The system of claim 16 wherein:
the vertical displacement operations are facilitated with a chain hoist system comprising a rail and at least one winch, wherein the rail is arranged in a vertical position connected to at least one tower among the subsequent tower sections, and the at least one chain hoist is located in the elevator as a part of a lifting system.

22. The system of claim 16:
wherein the vertical displacement operations are facilitated with a rack and pinion system comprising a rack and at least one pinion, wherein the rack is arranged in a vertical position connected to at least one tower among the subsequent tower sections, and the at least one pinion is located in the elevator as a part of a drive system;
wherein the vertical displacement operations are facilitated with a winch hoist system comprising a rail and at least one winch, wherein the rail is arranged in a vertical position connected to at least one tower among the subsequent tower sections, and the at least one winch is located in the elevator or ground as a part of a lifting system; and/or
wherein the vertical displacement operations are facilitated with a chain hoist system comprising a rail and at least one winch, wherein the rail is arranged in a vertical position connected to at least one tower among the subsequent tower sections, and the at least one chain hoist is located in the elevator as a part of a lifting system.
